(19) United States
(12) Patent Application Publication
(10) Pub. No.: US 2010/0007139 A1
(43) Pub. Date: Jan. 14, 2010

(54) COUPLER FOR CONNECTING METAL AND PLASTIC PIPES

(75) Inventor: KEVIN PIROTIN, FOOTHILL RANCH, CA (US)

Correspondence Address: LAW OFFICE OF CLAY MCGURK, P.O. BOX 6127, LAGUNA NIGUEL, CA, 92677, US

(73) Assignee: NORITZ AMERICA CORPORATION, FOUNTAIN VALLEY, CA (US)

(21) Appl. No.: 12/170,668

(22) Filed: Jul. 10, 2008

(51) Int. Cl. F16L 47/00

(52) U.S. Cl. 285/245

(57) ABSTRACT

The coupler is provided that has two ends or openings. On one end, the coupler is adapted for receiving a stainless steel pipe. The stainless steel pipe fits inside or into one end of the coupler and is securely and tightly held inside the coupler by a snap lock. An O-ring rests against the end of the stainless steel pipe and forms a seal when the stainless steel pipe is inserted into the coupler. On the other end, the coupler is adapted for receiving a plastic or PVC pipe. The plastic pipe fits inside a recessed opening of the coupler, and is securely and tightly held inside the coupler by a clamp lock or by glue. An O-ring rests against the end of the plastic pipe and forms a seal when the plastic pipe is inserted into the coupler.

### BACKGROUND OF THE INVENTION

The Noritz Corporation is a leading manufacturer of commercial and residential tankless water heaters. Noritz energy efficient hot water heaters can cut heating costs up to fifty percent and conserve wasted energy spent on heating a traditional tank water heater. Their compact commercial and residential water heaters conserve space and emit low levels of carbon dioxide. The space saving design of Noritz tankless gas water heaters allows for installation virtually anywhere, indoors or outdoors. These compact commercial and residential water heaters are extremely durable and provide an extended long life capacity.

Two of the critical parts of the tankless water heater are the exhaust vent and the air vent. The exhaust vent allows toxic gas or carbon dioxide to pass safely from the tankless water heater through the exhaust vent into the atmosphere. Some commercial and residential tankless hot water heater installations are required by code to use stainless steel venting. However, for high efficiency tankless water heaters that emit exhaust at significantly lower temperatures than traditional tankless water heaters, plastic-based vent systems can be utilitized in either commercial or residential applications. Plastic, including PVC piping is less expensive than stainless steel and can help save money on installation for residential and commercial applications. However, there is no coupler commercially available for joining stainless steel pipe with a plastic pipe for exhaust vent applications. What is therefore needed is a coupling or transition fitting for connecting the stainless steel pipe to a plastic pipe that is low in cost and easy to install.

### SUMMARY OF THE INVENTION

The exhaust vent coupler of the present invention has two ends or openings. On one end, the coupler is adapted for receiving a stainless steel pipe. The stainless steel pipe fits inside or into one end of the coupler and is securely and tightly held inside the coupler by a snap lock. An O-ring rests against the end of the stainless steel pipe and forms a seal for preventing toxic gas fumes or combustion exhaust from escaping when the stainless steel pipe and coupler are joined together. On the other end, the coupler is adapted for receiving a plastic or PVC pipe. The plastic pipe fits inside a recessed opening of the coupler, and is securely and tightly held inside the coupler by a clamp lock. An O-ring rests against the end of the plastic pipe and forms a seal for preventing toxic gas fumes from escaping when the plastic pipe and coupler are joined together. Therefore, when the stainless steel pipe and plastic pipe are inserted, the coupler has the advantage of forming a tight and secure passageway so that toxic gas fumes emitted by the tankless water heater flow through the exhaust vent (and coupler) into the atmosphere.

Other and further aspects and features of the invention will be evident from reading the following detailed description of the preferred embodiments, which are intended to illustrate and, not limit the invention.

### BRIEF DESCRIPTION OF THE DRAWINGS

The advantages and features of the present invention will become better understood with reference to the following more detailed description and claims taken in conjunction with the accompanying drawings, in which like elements are identified with like symbols, and in which:

FIG. 1 shows a front perspective view of the exhaust vent coupler with a snap lock and clamp lock according to the present invention; and

FIG. 2 shows a cross-sectional view of the exhaust vent coupler without the snap lock and clamp lock according to the present invention.

### DETAILED DESCRIPTION OF THE INVENTION

The following detailed description of the invention refers to the accompanying drawings. Although the description includes exemplary embodiments, other embodiments are possible, and changes may be made to the embodiments described without departing from the spirit and scope of the invention. Whenever possible, the same reference numbers will be used throughout the drawings and the following description to refer to the same and like parts.

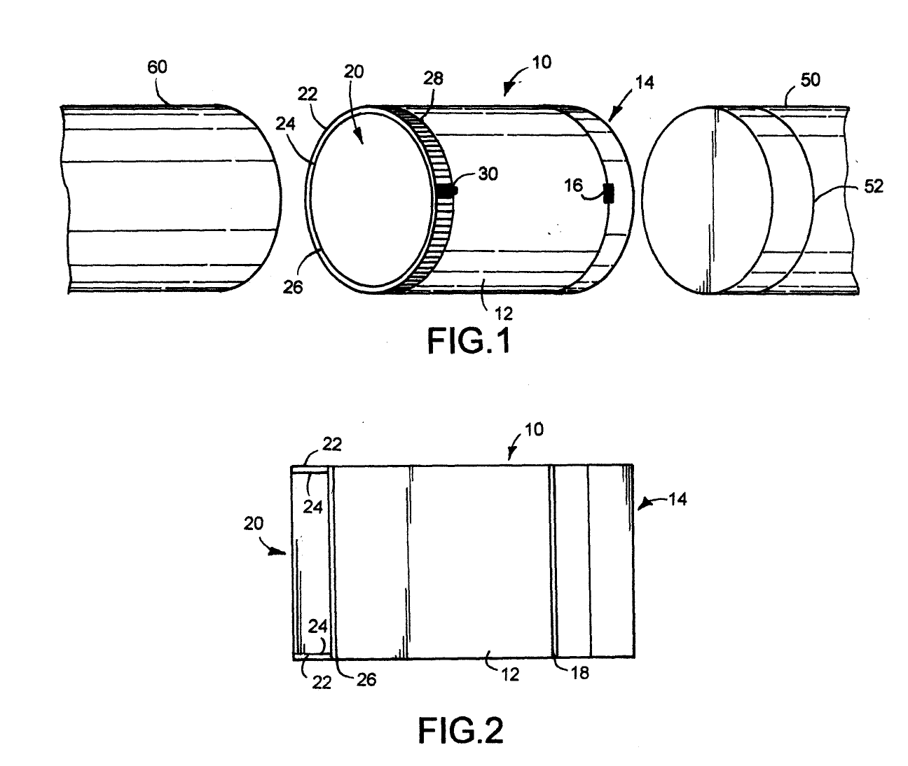

FIG. 1 shows a front perspective view of the exhaust vent coupler 10 according to the present invention. FIG. 2 show a cross-sectional view of the exhaust vent coupler 10 according the present invention. As shown in FIGS. 1, 2, the exhaust vent coupler 10 comprises a cylindrical body 12, openings 14, 20 at each end, snap lock 16, band clamp 28, and O-rings 18, 26. The coupler 10 has a cylindrical body 12. However, the coupler could have virtually any shape such as to conform to the shape or configuration of the exhaust vent pipes. For example, the exhaust vent coupler could have a rectangular shape for rectangular exhaust vent pipes. The coupler 10 is preferably made from one piece of metal, such as stainless steel, aluminum or steel. Other types of metals or materials such as copper, nickel, and plastic for example, could be used as well if they provide a durable, stable and sturdy base for joining metal and plastic pipes. Moreover, the coupler could be made out of a combination of materials, for example, metal on the side making contact with the metal pipe, and plastic on the side making contact with the plastic pipe.

The opening 14 at one end of the coupler 10 has a diameter that permits a stainless steel pipe 50 to be inserted into it. The stainless steel pipe 50 is inserted into the opening 14, whereby the inner surface of the opening 14 of coupler 10 and the outer surface of the stainless steel pipe 50 make contact. The coupler 10 and pipe 50 should make sufficient contact, whereby the stainless steel pipe 50 can freely be inserted or removed by sufficient pressure as applied by an installer.

When the stainless steel pipe 50 is inserted into coupler 10, the end of the pipe 50 will fit tightly or closely against O-ring 18. The O-ring 18 is a seal. This seal is important so that gas or other noxious fumes will not escape from the coupler 10 when the pipe 50 is attached to it. The O-ring 18 is a commercially available rubber gasket for forming a seal when the coupler 10 and pipe 50 are joined together. The shape of the O-ring 18 is circular for the present invention, although it will be appreciated that the O-ring 18 could have a shape to conform to the shape of the exhaust vent. The O-ring 18 is the preferred way to seal the connection between the coupler 10 and stainless steel pipe 50. However, it will be appreciated by those skilled in the art that there are number of ways of sealing the connection between the coupler 10 and the stainless steel pipe 50 other than by using an O-ring 18. For example, silicone sealant and aluminum tape could be used in place of the O-ring.

Stainless steel pipe 50 has a groove 52 that is some predetermined distance from the end of the pipe 50. The groove 52 in stainless steel pipe 50 will make contact with the snap lock 16 of coupler 10, whereby the stainless steel pipe 50 will be securely held into opening 14 of coupler 10. When the snap lock 16 is released, it will release the stainless steel pipe 50 from the coupler 10, so that the stainless steel pipe 50 can be removed from coupler 10 by an installer. Snap lock 16 is commercially available and is commonly used in the industry for joining stainless steel pipes together. In alternative embodiments, snap lock 16 could be replaced by other commercially available locking devices means such as a clamp lock, for example.

On the other end of coupler 10, there is a recessed opening 20 that is adapted for receiving and securely holding a commercially available plastic or PVC pipe 60. The recessed opening 20 has a particular diameter and has an outer side 22 and an inner side 24. The diameter of the opening 20 is specifically tailored to match the diameter of commercially available plastic pipes 60. For example, for a commercially available plastic pipe 60 having a diameter of six inches, the diameter of the recessed opening 20 of coupler 10 would be approximately a little more than six inches. Although six inches was chosen by way of illustration, it will be appreciated that commercially available plastic pipes 60 come in a variety of sizes (other than six inches), and the coupler can be manufactured to conform to the specific size of standard, commercially available plastic pipes 60.

When the plastic pipe 60 is inserted into the recessed opening 20, the outer surface of the pipe 60 slides under outer side 22, while the inner surface of the pipe 60 makes contact with the inner side 24 of recessed opening 20. The plastic pipe 60 further slides into recessed opening 20 by some predetermined distance. When the plastic pipe 60 is fully inserted into the recessed opening 20, the plastic pipe 60 rests against an O-ring 26 to form a snug or tight connection inside coupler 10. There is enough movement or give in the width between the outer surface 22 and the inner surface 24 so that the pipe 60 can freely be inserted or removed from the coupler 10 when enough pressure is applied by the installer. However, in the preferred embodiment, a band clamp 28 is used to firmly secure and hold the plastic pipe 60 inside the coupler 10.

The width or distance between the outer side 22 and the inner side 24 is approximately the same as the width of the rim of the plastic pipe 60 being used. For example, if the plastic pipe 60 has a two millimeter width (and this is not referring to the diameter of the pipe 60 itself), the width or distance between the outer side 22 and inner side 24 would be approximately 2.5 millimeters. However, it will be appreciated that there are other widths that could be used as well, and 2.5 millimeters was chosen for purposes of illustration only.

At the inside end of the recessed opening 20 and at the inside end of the surfaces or sides 22, 24 is an O-ring 26. The O-ring 26 is commercially available and matches the diameter of the recessed opening 20 of coupler 10. The O-ring 26 is important to prevent gas or other noxious fumes from escaping when the plastic pipe 60 is attached to the coupler 10. Although an O-ring is preferred, there are other alternative ways for forming a seal, such as using soft rubber or glue for example. In the alternative embodiment where glue is used, the O-ring would not be needed and would be replaced by gluing the plastic pipe 60 to the recessed opening 20 of coupler 10.

The band clamp 28 fits around the outer side 22 of the recessed opening 20 of coupler 10. The band clamp 28 is tightened by rotating screw 32. Upon tightening of the screw 32, a radial and compressive force is exerted by the band clamp 28 on the outer surface 22 of the coupler 20 and the plastic pipe 60. The band clamp 28 securely and tightly holds the plastic pipe 60 into the coupler 10. The plastic pipe 60 would not be released from the coupler 10 until the band clamp 28 is loosened. The band clamp 28 is commercially available. In alternative embodiments, a band clamp is not necessarily needed, and glue may be used to form a bond and seal between the plastic pipe. However in this alternative embodiment, the bond and seal are permanent, whereas the preferred embodiment, the seal can be released by the loosening of the band clamp. Any glue that is commercially available can be used, but pipe glue is preferred.

When the stainless steel pipe 50 and plastic pipe 60 are securely inserted and firmly held by the coupler 10, this forms a coupler so that toxic gas fumes can be transferred from the tankless water heater into the atmosphere. Although the coupler 10 is referred to throughout this application, alternative names that could be used as well are adaptor, transition device and/or apparatus, and/or housing, for example.

In the preferred embodiment, the size of stainless steel opening 14 is approximately equal to the size of the plastic pipe opening 20. However, it can be appreciated by those skilled in the art that these two openings 14 and 20, do not have to be equal. For example, the stainless steel opening 14 could have a larger opening than the size of the plastic pipe opening 20, and visa versa. Moreover, the shape of the openings could differ as well. For example, the stainless steel opening 14 could have a rectangular shape, while the plastic pipe opening 20 could be circular, and visa versa.

This coupler or adapter is intended for the water heater exhaust, however it can also be used for the combustion air intake of the tankless water heater. It can also be used in some tankless water heater configurations that employ a two pipe design: one pipe for the exhaust, and one pipe for the intake air. This adapter is used for transitioning from metal to plastic pipe on both sides.

The coupler or adapter is meant for commercial or residential applications that utilize a high efficiency tankless water heater. It can be appreciated that the coupler could also be used for other high efficiency appliances such as furnaces and boilers, for example.

Particular embodiments of the present inventions have been shown and described, and it will be understood that it is not intended to limit the present inventions to the preferred embodiments. It will be obvious to those skilled in the art that various changes and modifications may be made without departing from the spirit and scope of the present inventions. Thus, the present inventions are intended to cover alternatives, modifications and equivalents, which may be included within the spirit and scope of the present inventions as defined herein.

What is claimed is:

1. A coupler, comprising:
a body having at least two ends, a first end adapted for receiving a first pipe and a second end adapted for receiving a second pipe;
a first seal located inside the first end of the body and adapted for sealing a connection between an end of the first pipe and the body when the first pipe is inserted into the body;
first locking means for securely holding the first pipe into the first end of the body when the first pipe is inserted into the body;
a second seal located inside the second end of the body and capable of sealing a connection between an end of the second pipe and the body when the second pipe is inserted into the body; and
second locking means for securely holding the second pipe into the second end of the body when the second pipe is inserted into the body.

2. The coupler as claimed in claim 1, wherein the body is cylindrical in shape and formed of stainless steel.

3. The coupler as claimed in claim 1, wherein the body is cylindrical in shape and formed of plastic.

4. The coupler as claimed in claim 1, wherein the body is rectangular in shape and formed of stainless steel.

5. The coupler as claimed in claim 1, wherein the body is rectangular in shape and formed of plastic.

6. The coupler as claimed in claim 1, wherein the first and second seals are O-rings.

7. The coupler as claimed in claim 1, wherein the first and second seals are made of rubber.

8. The coupler as claimed in claim 1, wherein the first seal is an O-ring, and the second seal is formed by gluing the second pipe inside the second end.

9. The coupler as claimed in claim 1, wherein the first locking means is a snap lock.

10. The coupler as claimed in claim 1, wherein the second locking means is a clamp lock.

11. The coupler as claimed in claim 1, wherein the second end has a recessed opening having an outer side and an inner side, the outside side surrounds an outer surface of the second pipe, and the inner side surrounds an inner surface of the second pipe.

12. A coupler, comprising:
a body having at least two ends, a first end adapted for receiving a first pipe, and a second end having a recessed opening and adapted for receiving a second pipe;
a first O-ring located inside the first end of the body and capable of sealing a connection between an end of the first pipe and the body when the first pipe is inserted into the body;
first locking means for securely holding the first pipe into the first end of the body when the first pipe is inserted into the body;
a second O-ring located inside the second end of the body and capable of sealing a connection between an end of the second pipe and the body when the second pipe is inserted into the body; and
second locking means for securely holding the second pipe into the second end of the body when the second pipe is inserted into the body.

13. The coupler as claimed in claim 12, wherein the first locking means is a snap lock.

14. The coupler as claimed in claim 12, wherein the second locking means is a clamp lock.

15. A coupler, comprising:
a body having at least two ends, a first end adapted for receiving a first pipe, and a second end having a recessed opening and adapted for receiving a second pipe;
a first O-ring located inside the first end of the body and capable of sealing a connection between an end of the first pipe and the body when the first pipe is inserted into the body;
a snap lock capable of securely holding the first pipe into the first end of the body when the first pipe is inserted into the body;
a second O-ring located inside the second end of the body and capable of sealing a connection between an end of the second pipe and the body when the second pipe is inserted into the body; and
clamp lock capable of securely holding the second pipe into the second recessed end of the body when the second pipe is inserted into the body.

16. The coupler as claimed in claim 15, wherein the body is cylindrical in shape and made of stainless steel.

17. The coupler as claimed in claim 15, wherein the body is cylindrical in shape and made of plastic.
